(19) United States
(12) Patent Application Publication
(10) Pub. No.: US 2006/0256872 A1
(43) Pub. Date: Nov. 16, 2006

(54) FILTERING CHARACTERISTIC ERROR CONCEALING APPARATUS

(75) Inventor: Kotaro Esaki, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/382,804

(22) Filed: May 11, 2006

(30) Foreign Application Priority Data
May 13, 2005 (JP) 2005/141938

(51) Int. Cl. H04B 1/66; H04N 11/02; H04N 11/04; H04N 7/12

(52) U.S. Cl. 375/240.27; 375/240.24

(57) ABSTRACT

A filtering characteristic error concealing apparatus according to the present invention has: a calculation unit whch calculates a characteristic value of each block included in a picture, the characteristic value being used in deblocking filtering for the bock and representing strength of the deblocking filtering; a control unit which controls the calculation unit (i) to start and terminate the calculation for the block, and (ii) to designate locations of boundaries of the block; an error detection unit which detects an error related to the calculation; and a mask circuit which conceals deblocking filtering that is performed for each of a block for which the error is detected and blocks subsequent to the block with the error, when the error is detected.

### BACKGROUND OF THE INVENTION

(1) Field of the Invention

The present invention relates to an apparatus which conceals an erroneous characteristic value in deblocking filtering, more specifically to a filtering characteristic error concealing apparatus which conceals an erroneous characteristic value that is falsely calculated in deblocking filtering by a picture coding device or a picture decoding device, when a unit for calculating the value operates in error.

(2) Description of the Related Art

Conventionally, a device for coding or decoding a picture filters the picture in order to reduce distortion occurred on edges between blocks in the picture, due to compression of the picture data. The filtering is generally called deblocking filtering.

FIG. 1 is a block diagram showing a structure of the conventional picture coding device. Referring to FIG. 1, a deblocking filter A06 filters a picture which is applied with inverse quantization and inverse orthogonal transformation by a picture decoding unit A04 and then re-constructed by an adder A05. Because of such a function, this deblocking filter A06 performs, as shown in FIG. 1, the filtering processing between the adding of the adder A05 and storing of a memory A07 that holds reference pictures, as disclosed, for example, in Japanese Patent Laid-Open No. 2003-179933 publication, FIG. 2.

FIG. 2 is a block diagram showing a structure of the conventional deblocking filter A06. The deblocking filter A06 includes: a characteristic setting unit B02 which sets a characteristic value that is used in filtering applied to each block boundary and that represents filter strength in the filtering; and a filtering unit B03 which selects a type of filtering based on the characteristic value in order to eventually filter a decoded picture. The above is disclosed, for example, in Japanese Patent Laid-Open No. 11-275584 publication (FIG. 2).

Referring to FIGS. 3A and 3B, in a current macroblock, filtering is applied to each block (i×j pixels, in FIGS. 3A and 3B) obtained by segmenting M×N pixels of the macroblock into each predetermined unit pixels. In the block to be filtered (hereinafter, referred to as a current block), filtering is applied to pixels on both sides of a boundary in the current block and an adjacent block positioned immediately above or on the immediately left of the current block. Here, a characteristic value used to filter block boundaries in each block is set by the characteristic setting unit B02. In H.264/MPEG-4AVC standard, such a characteristic value is defined as boundary strength (bS).

This means that the conventional picture coding device or picture decoding device decides the filtering characteristic value on a block-by-block basis, by the characteristic setting unit shown in FIG. 2.

### SUMMARY OF THE INVENTION

In the conventional coding or decoding technology, as shown in FIG. 2, the characteristic setting unit B02 calculates the characteristic value used to filter block boundaries in each block, using a relationship between coding information regarding a current macroblock, and coding information regarding an adjacent macroblocks positioned immediately above or on the immediately left of the current macroblock. Then, the deblocking filter unit B03 filters the decoded picture by selecting a type of filtering based on the characteristic value.

However, there is the following problem. Such characteristic setting unit B02 calculates the filtering characteristic value for each block boundary using sequentially-inputted coding information. Therefore, when, for example, the inputted coding information is false, a characteristic value is calculated using the false coding information, so that filtering is performed using the erroneous characteristic value, which fails to properly filter the decoded picture, resulting in deterioration of image quality of the picture.

Moreover, there is another problem as following. The characteristic setting unit B02 generally includes a control unit 902 and a calculation unit 901 as shown in FIG. 4. Therefore, when the control unit 902 is stopped (stopped state) or operates out of control (runaway state), due to an internal cause such as false control algorithm or an external cause such as a noise, the calculation unit 901 fails to properly calculate the characteristic value. Furthermore, in some situations, the calculation unit 901 would repeatedly outputs an identical characteristic value or continues to calculate erroneous characteristic values. In those cases, the deblocking filter unit B03 at a next stage filters blocks using the erroneous characteristic values, which eventually results in almost deterioration of image quality of the decoded picture. In addition, depending on the structure of the control unit 902, such a problem sometimes causes the entire picture coding or decoding device to get into a stopped state or a runaway state.

The present invention is conceived to solve the above problems, and an object of the present invention is to provide a filtering characteristic error concealing apparatus, a filtering characteristic error concealing method, and a picture coding device and a picture decoding device, each of which conceals an erroneous characteristic value when an error related to calculation of the characteristic value occurs, in order to prevent from deterioration of image quality of a decoded picture, without affecting performance of the picture coding or decoding device.

In order to solve the above problems, a filter characteristic error concealing apparatus according to the present invention includes: a calculation unit operable to calculate a characteristic value of each block included in a picture, the characteristic value being used in deblocking filtering for the bock and representing strength of the deblocking filtering; a control unit operable to control the calculation unit (i) to start and terminate the calculation for the block, and (ii) to designate locations of boundaries of the block; a detection unit operable to detect an error related to the calculation; and a concealment unit operable to conceal deblocking filtering that is performed for each of a block for which the error is detected and blocks subsequent to the block with the error, when the error is detected.

Thereby, when an error is detected in the characteristic value calculation, the error in deblocking filtering can be concealed. This makes it possible to prevent image quality deterioration resulted from erroneous deblocking filtering caused by the error in deblocking filtering. This also makes it possible to prevent that one falsely-calculated characteristic value affects subsequent calculation, and erroneous characteristic values are generated for blocks subsequent to the block for which the error has been detected.

Here, the calculation unit may calculate the characteristic value, based on a coding parameter representing information regarding a method of coding the picture, and the detection unit may detect the error, by judging whether or not the coding parameter is within a predetermined value range.

Thereby, it is possible to conceal deblocking filtering using the erroneous characteristic value calculated using erroneous coding parameters. This makes it possible to prevent image quality deterioration resulted from erroneous deblocking filtering.

Here, the detection unit may detect the error, by judging whether or not the characteristic value calculated by the calculation unit is within a predetermined value range.

Here, the control unit may have: a sequence circuit operable to control the calculation unit; and a state register which holds information regarding a state of the sequence circuit, and the detection unit may detect the error, by judging whether or not transition of the states of the sequence circuit proceeds normally.

Thereby, it is possible to prevent image quality deterioration resulted from false deblocking filtering caused by erroneous state transition of the sequence circuit.

Here, the control unit may have: a sequence circuit operable to control the calculation unit; and a state register which holds information regarding a state of the sequence circuit, and the detection unit may detect the error, by judging whether or not the control unit is in a runaway state.

Thereby, it is possible to prevent image quality deterioration resulted from erroneous deblocking filtering caused by a runaway state of the control unit or the like.

Here, the control unit may be initialized in starting calculation of a characteristic value for a first block in a macroblock which is subsequent to a macroblock including a block for which the error is detected, when the error is detected.

Thereby, when an error is detected, it is possible to restore a normal state of the deblocking filtering in order to filter next macroblock.

Here, the concealment unit may replace the erroneous characteristic value by an alternative value to be used in deblocking filtering, for each of a block for which the error is detected and blocks subsequent to the block with the error.

Thereby, after the runaway sate is detected, only a limited part of a macroblock in which an error occurs is not filtered, and for macroblocks subsequent to the macroblock, normal characteristic values are calculated. This makes it possible to prevent image quality deterioration, ensuring performance of the picture coding or decoding device.

Here, the concealment unit may replace the erroneous characteristic value by an alternative value to be used in deblocking filtering, for each of a block for which the error is detected and blocks subsequent to the block with the error.

Thereby, the erroneous characteristic value is replaced by an alternative value, such as the weakest filter strength or the strongest filter strength, in order to be used for deblocking filtering. This makes it possible to prevent image quality deterioration.

Here, the concealment unit may have a characteristic table which holds a representative characteristic value, and the concealment unit may replace the erroneous characteristic value by the representative characteristic value to be used in deblocking filtering, for each of a block for which the error is detected and blocks subsequent to the block with the error.

Thereby, when an error is detected, it is possible to perform deblocking filtering using a representative characteristic value.

Here, the characteristic table may hold the representative value corresponding to a location of each block in the picture.

Thereby, when an error is detected, it is possible to perform deblocking filtering using a representative characteristic value corresponding to a location of the current block.

Here, the concealment unit may have a storage unit which stores a calculated characteristic value for each block, and the concealment unit may replace the erroneous characteristic value by the stored characteristic value to be used in deblocking filtering, for each of the block for which the error is detected and blocks subsequent to the block with the error.

Thereby, when an error is detected, it is possible to perform more appropriate deblocking filtering using a compensation characteristic value which is a characteristic value used for another block in the same picture.

Here, the concealment unit may replace the erroneous characteristic value by a characteristic value for a block adjacent to a current block, in order to be used in deblocking filtering, for each of a block for which the error is detected and blocks subsequent to the block with error.

Thereby, when an error is detected, it is possible to perform more appropriate deblocking filtering using a compensation characteristic value which is a characteristic value used for a block adjacent to the current block in the same picture, instead of the erroneous characteristic value.

Here, the characteristic value may include a horizontal boundary value used to filter a horizontal boundary in a block, and a is vertical boundary value used to filter a vertical boundary in a block, the concealment unit may replace the erroneous characteristic value by a characteristic value including (a) a horizontal boundary value for a block which is positioned immediately above the current block, and (b) a vertical boundary value for a block which is positioned on immediately left of a current block, in order to be used in deblocking filtering, for each of a block for which the error is detected and blocks subsequent to the block with the error.

Thereby, each of a block in which an error occurs and blocks subsequent to the block is filtered using each characteristic value having a horizontal boundary value and a vertical boundary value, which are independently correlated to a vertical boundary value and a horizontal boundary value, respectively of a true characteristic value of the current block. This makes it possible to prevent almost deterioration of seeming image quality of a resulting decoded picture including the macroblock in which the error occurs, ensuring performance of the whole picture coding or decoding device.

Here, the storage unit may store: a characteristic value of each block included in a current macroblock which is currently decoded; and a characteristic value of each block included in a macroblock positioned immediately prior to the current macroblock, and the concealment unit may replace the erroneous characteristic value by a characteristic value for the block included in the macroblock positioned immediately prior to the current macroblock, in order to be used in deblocking filtering, for each of a block for which the error is detected and blocks subsequent to the block with the error.

Thereby, each of the block for which the error is detected and blocks subsequent to the block is filtered using each characteristic value for a block which is in a macroblock immediately prior to the current macroblock and which is correlated with the current block. This makes it possible to prevent almost deterioration of seeming image quality of a resulting decoded picture including the macroblock in which the error occurs, ensuring performance of the whole picture coding or decoding device.

Here, the storage unit may store calculated characteristic values for respective blocks included in macroblocks whose number is equal to the number of macroblocks in one macroblock line, the macroblocks being followed by a current macroblock, and the concealment unit may replace the erroneous characteristic value by a characteristic value for a block which is included in a macroblock adjacent to the current macroblock and which is positioned in the adjacent macroblock at the same location of a current block, in order to be used in deblocking filtering, for each of a block for which the error is detected and blocks subsequent to the block with the error.

Thereby, each of the block for which the error is detected and blocks subsequent to the block is filtered using each compensation characteristic value having (a) a horizontal boundary value for a block which is included in another adjacent macroblock positioned immediately above the current macroblock and which is positioned in the above macroblock at the same location of the current block, and (b) a vertical boundary value for a block which is included in an adjacent macroblock positioned on the immediately left of the current macroblock and which is positioned in the left macroblock at the same location of the current block. This makes it possible to prevent almost deterioration of image quality.

Here, the concealment unit may have: a characteristic table which holds a representative characteristic value; and a storage unit which stores a calculated characteristic value for each block, and the concealment unit may (a) replace the erroneous characteristic value by a calculated characteristic value for a block adjacent to the current block when the storage unit stores the characteristic value for the adjacent block, and (b) replace the erroneous characteristic value by a representative characteristic value stored in the representative table when the storage unit does not store the characteristic value for the adjacent block, in order to be used in deblocking filtering, for each of a block for which the error is detected and blocks subsequent to the block, when the error is detected.

Here, in the characteristic table, the characteristic value may be able to be written and read out, at a arbitrary timing.

Thereby, it is possible to update representative characteristic values at any time on a slice-by-slice basis, a picture-by-picture basis, for example, thereby compensating for a falsely calculated characteristic value by the representative value which is more similar to a true characteristic value of the current block, compare to the fixed representative value. This makes it possible to prevent almost deterioration of seeming image quality of a resulting decoded picture including the macroblock in which the error occurs, ensuring performance of the whole picture coding or decoding device.

Here, the control unit may control the calculation unit to re-calculate the erroneous characteristic value, prior to completion of the concealing performed by the concealment unit, when the error is detected.

Further, the filter characteristic error concealing method, the picture coding device, and the picture decoding device according to the present invention also have the above-described units, or steps executed by the above-described units.

Moreover, the above-described filter characteristic error concealing apparatus may be modified to the followings.

The concealment unit may replace the erroneous characteristic value by a characteristic value for a block which is included in a macroblock immediately prior to the current macroblock and which is positioned in the prior macroblock at the same location as the current block, in order to be used in deblocking filtering, for each of a block for which the error is detected and blocks subsequent to the block with the error.

Thereby, each of the block for which the error is detected and blocks subsequent to the blocks is filtered using the characteristic value in the adjacent macroblock which is correlated with a true characteristic for the current block. This makes it possible to prevent almost deterioration of seeming image quality of a resulting decoded picture including the macroblock in which the error occurs, ensuring performance of the whole picture coding or decoding device.

Here, the concealment unit may replace the erroneous characteristic value by a characteristic value, which is obtained by comparing a characteristic value for a block adjacent to the current block with a characteristic value for a block which is included in a macroblock immediately prior to the current macroblock and which is positioned in the prior macroblock at the same location as the current block, and if the characteristic values and are the same, reading the characteristic value from the storage unit, while if the characteristic values and are not the same, reading the characteristic value from the storage unit, in order to be used in deblocking filtering, for each of a block for which the error is detected and blocks subsequent to the block with the error.

Thereby, each of the block for which the error is detected and blocks subsequent to the block is filtered using a compensation characteristic value, which is selected from the characteristic value for a block adjacent to the current block or the characteristic value for a block which is included in a macroblock immediately prior to the current macroblock and which is positioned in the prior macroblock at the same location as the current block, so that the selected characteristic value is more correlated with a true characteristic value for the current block, compared to the non-selected characteristic value. This makes it possible to prevent deterioration of seeming image quality of a resulting decoded picture.

Here, the characteristic value may include a horizontal boundary value used to filter a horizontal boundary in a block and a vertical boundary value used to filter a vertical boundary in the block. The concealment unit may replace the erroneous characteristic value by a characteristic value which has a horizontal boundary value for a block which is included in a macroblock immediately above the current macroblock and which is positioned in the above macroblock at the same location of the current block and a vertical boundary value for a block which is included in a macroblock on the immediately left of the current macroblock and which is positioned in the left macroblock at the same location of the current block, in order to be used in deblocking filtering, for each of a block for which the error is detected and blocks subsequent to the block with the error.

Thereby, each of the block for which the error is detected and blocks subsequent to the block is filtered using each characteristic value having a horizontal boundary value and a vertical boundary value, each of which is independently correlated with a true horizontal or vertical boundary value for the current block. This makes it possible to prevent almost deterioration of seeming image quality of a resulting decoded picture including the macroblock in which the error occurs, ensuring performance of the whole picture coding or decoding device.

Here, the concealment unit may replace the erroneous characteristic value by an average value, a maximum value, or a minimum values, which is calculated from a characteristic value for a block which is in a macroblock on the immediately left of the current macroblock and which is positioned in the immediately left macroblock at the same location as the current block, and a characteristic value for a block which is in a macroblock immediately above the current macroblock and which is positioned in the above macroblock at the same location as the current block, in order to be used in deblocking filtering, for each of a block for which the error is detected and blocks subsequent to the block with the error.

Thereby, each of the block for which the error is detected and blocks subsequent to the block is filtered using characteristic values from the macroblock on the immediately left of the current macroblock and the macroblock immediately above the current macroblock, each or which is correlated with a true characteristic value for the current block. This makes it possible to prevent almost deterioration of seeming image quality of a resulting decoded picture including the macroblock in which the error occurs, ensuring performance of the whole picture coding or decoding device.

Here, the concealment unit may replace the erroneous characteristic value by a characteristic value, which is obtained by comparing a characteristic value of a block which is in the current macroblock and positioned adjacent to the current block, a characteristic value of a block which is in an adjacent macroblock positioned on the immediately left of the current macroblock and which is positioned in the left macroblock at the same location as the current block, and a characteristic value of a block which is in another adjacent macroblock positioned immedicately above the current macroblock and which is positioned in the above macroblock at the same location as the current block, and if the characteristic value for the adjacent block is the same as the characteristic values for the blocks in the adjacent macroblocks, selecting the characteristic values for the block in the adjacent macroblocks, while if the characteristic value for the adjacent block is not the same as the characteristic value for the block in the adjacent macroblock, then selecting the characteristic value for the adjacent block, in order to be used in deblocking filtering, for each of a block for which the error is detected and blocks subsequent to the block with the error.

Thereby, each of the block for which the error is detected and blocks subsequent to the block is filtered using each characteristic value which is more correlated with a true characteristic for the current block, among the characteristic values for the adjacent block and the blocks in the adjacent macroblocks. This makes it possible to prevent almost deterioration of seeming image quality of a resulting decoded picture including the macroblock in which the error occurs, ensuring performance of the whole picture coding or decoding device.

Here, when the characteristic value for the block adjacent to the current block is not stored, the concealment unit may replace the erroneous characteristic value by an average value of the representative characteristic value stored in the characteristic table and an already-calculated characteristic value for a block nearest to the current block.

Here, when the detecting unit detects an error, the concealment unit may calculate again the calculated characteristic value and subsequently calculated characteristic values, by estimating an idle time and limiting blocks to be filtered, so that the re-calculation for the limited blocks completes within the idle time.

Thereby, the re-calculation of characteristic values is performed by limiting boundaries to be filtered. This makes it possible to prevent almost deterioration of seeming image quality of a resulting decoded picture including the macroblock in which the error occurs, ensuring performance of the whole picture coding or decoding device.

The filter characteristic error concealing apparatus, the filter characteristic error compensating method, and the picture coding device, and the picture decoding device according to the present invention can conceal the falsely-calculated characteristic value by using, instead of the falsely-calculated characteristic value, a compensating value to be used in deblocking filtering, when an error is detected in the characteristic value calculation. This makes it possible to prevent from deterioration of image quality resulted from the erroneous deblocking filtering. Further, this also makes it possible to present that the falsely-calculated characteristic value affects calculation of subsequent characteristic values.

Still further, deblocking filtering using the erroneous characteristic value calculated by an erroneous coding parameter is compensated, so that it is possible to prevent from deterioration of the image quality resulted from the erroneous deblocking filtering.

Still further, it is possible to prevent from deterioration of image quality, which is resulted from erroneous deblocking filtering caused by erroneous state transition in the sequence circuit.

Still further, it is possible to prevent from deterioration of image quality, which is resulted from erroneous deblocking filtering caused by a runaway state of the control unit or the like.

Still further, it is possible to recover a normal state in order to filter next macroblock, when an error is detected.

After the runaway sate is detected, deblocking filtering is not performed only for blocks in the current macroblock, but for blocks in subsequent macroblocks, deblocking filtering is performed normally to calculate correct characteristic values. This makes it possible to prevent almost deterioration of seeming image quality of a resulting decoded picture including the macroblock in which the error occurs, ensuring performance of the whole picture coding or decoding device.

The erroneous characteristic value is changed to an alternative value, such as the weakest filter strength or the strongest filter strength, in order to be used in deblocking filtering. This makes it possible to prevent almost deterioration of seeming image quality of a resulting decoded picture.

When an error is detected, deblocking filtering can be performed using a compensation characteristic value instead of the falsely-calculated characteristic value.

When an error is detected, deblocking filtering can be performed, on a block-by-block basis, using a compensation characteristic value depending on a location of a current block.

When an error is detected, more appropriate deblocking filtering can be performed using an already-calculated characteristic value for another block in the same picture, as a compensation characteristic value.

When an error is detected, more appropriate deblocking filtering can be performed using an already-calculated characteristic value for blocks adjacent to the current block in the same picture, as a compensation characteristic value.

Thereby, each of the block for which the error is detected and blocks subsequent to the block is filtered using each characteristic value having a horizontal boundary value and a vertical boundary value, each of which is independently correlated with a true value for the current block. This makes it possible to prevent almost deterioration of seeming image quality of a resulting decoded picture including the macroblock in which the error occurs, ensuring performance of the whole picture coding or decoding device.

Thereby, each of the block for which the error is detected and blocks subsequent to the block is filtered using each characteristic value of a block in a macroblock immediately prior to the current macroblock, which is correlated with a true value for the current block. This makes it possible to prevent almost deterioration of seeming image quality of a resulting decoded picture including the macroblock in which the error occurs, ensuring performance of the whole picture coding or decoding device.

Thereby, each of the block for which the error is detected and blocks subsequent to the block is filtered using each characteristic value of a block which is in a macroblock immediately prior to the current macroblock and which is positioned in the prior macroblock at the same location as the current block, which is correlated with a true value for the current block. This makes it possible to prevent almost deterioration of seeming image quality of a resulting decoded picture including the macroblock in which the error occurs, ensuring performance of the whole picture coding or decoding device.

### FURTHER INFORMATION ABOUT TECHNICAL BACKGROUND TO THIS APPLICATION

The disclosure of Japanese Patent Application No. 2005-141938 filed on May 13, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate specific embodiments of the present invention. In the

Drawings:

FIG. 1 is a block diagram showing a structure of a conventional picture coding unit;

FIG. 2 is a block diagram showing a structure of a deblocking filter;

FIG. 3A is a diagram showing a macroblock and a unit block to be filtered;

FIG. 3B is a diagram showing a macroblock and unit blocks to be filtered;

FIG. 4 is a diagram showing a structure of a characteristic setting unit according to a conventional technology;

FIG. 5 is a block diagram showing a structure of a picture coding device according to the first embodiment;

FIG. 6 is a block diagram showing a structure of a characteristic setting unit;

FIG. 7 is an explanatory diagram showing a macroblock having M×N pixels and a block having i×j pixels;

FIG. 8 is an explanatory diagram showing a block for which an error is detected;

FIG. 9 is a diagram showing a result of filtering characteristic error concealing processing;

FIG. 10 is a block diagram showing in detail structures of a calculation unit and a control unit;

FIG. 11 is a block diagram showing in detail a structure of an error detection unit;

FIG. 12 is a diagram showing one example of state transition;

FIG. 13 is a table showing the state transition;

FIG. 14 is a block diagram showing a structure of a characteristic setting unit according to the second embodiment;

FIG. 15 is a diagram showing a result of filtering characteristic error concealing processing;

FIG. 16 is a block diagram showing a structure of a characteristic setting unit according to the third embodiment;

FIG. 17 is a diagram showing a result of filtering characteristic error concealing processing;

FIG. 18 is a block diagram showing a structure of a characteristic setting unit according to the fourth embodiment;

FIG. 19 is a diagram showing a result of filtering characteristic error concealing processing;

FIG. 20 is a block diagram showing a structure of a characteristic setting unit according to the fifth embodiment;

FIG. 21 is a diagram showing a result of filtering characteristic error concealing processing;

FIG. 22 is a block diagram showing a structure of a characteristic setting unit according to the sixth embodiment;

FIG. 23 is a diagram showing a result of filtering characteristic error concealing processing;

FIG. 24 is a block diagram showing a structure of a characteristic setting unit according to the seventh embodiment;

FIG. 25 is a block diagram showing a structure of a characteristic setting unit according to the eighth embodiment; and

FIG. 26 is a diagram showing a result of filtering characteristic error concealing processing.

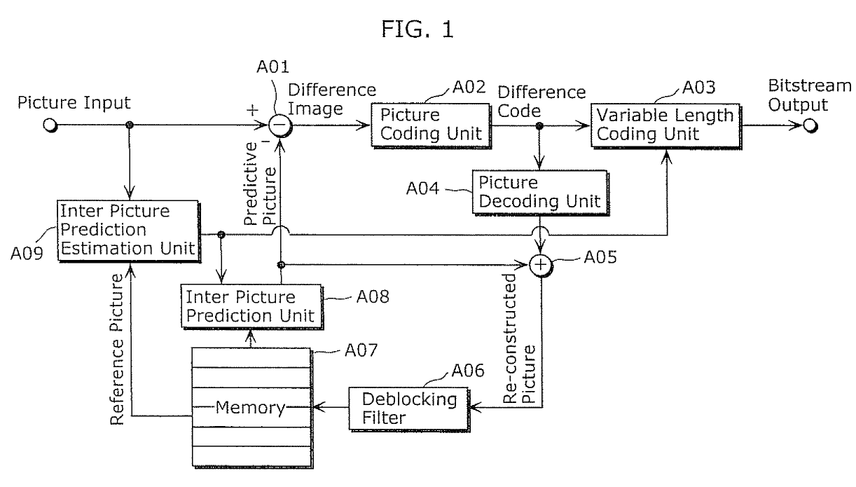

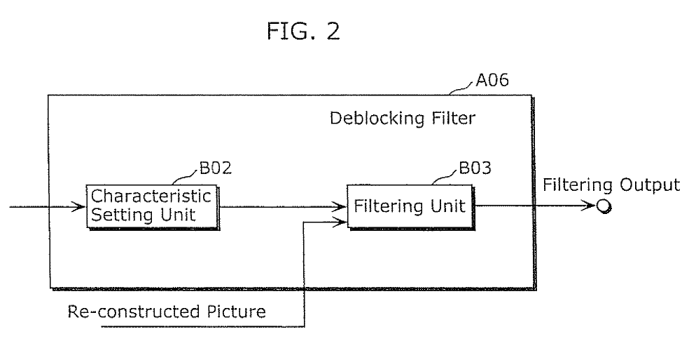

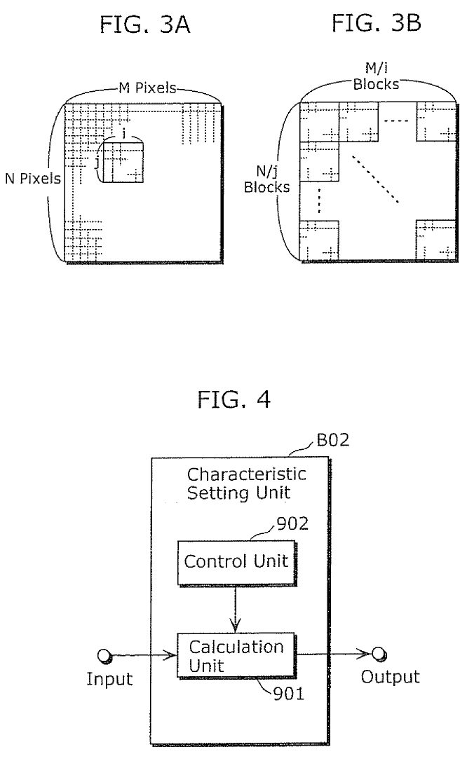

### DESCRIPTION OF THE PREFERRED EMBODIMENT(S)

The following describes preferred embodiments according to the present invention with reference to the drawings.

### First Embodiment

In a picture coding device according to the first embodiment, in order to perform deblocking filtering to reduce distortion occurred on edges between blocks in each macroblock in a picture due to compression of data of the picture, when a characteristic value representing filter strength used in the filtering is calculated for each block using information regarding boundaries in macroblocks adjacent to a current macroblock and information regarding boundaries in the current macroblock, if a malfunction occurs in the calculating of the characteristic value due to an internal cause such as false information setting or an external cause such as a noise, the falsely-calculated characteristic value and subsequently-calculated characteristic values are all replaced by a value of 0, in order to forcibly prohibit from deblocking filtering, and then the device system restores a normal state for a next macroblock.

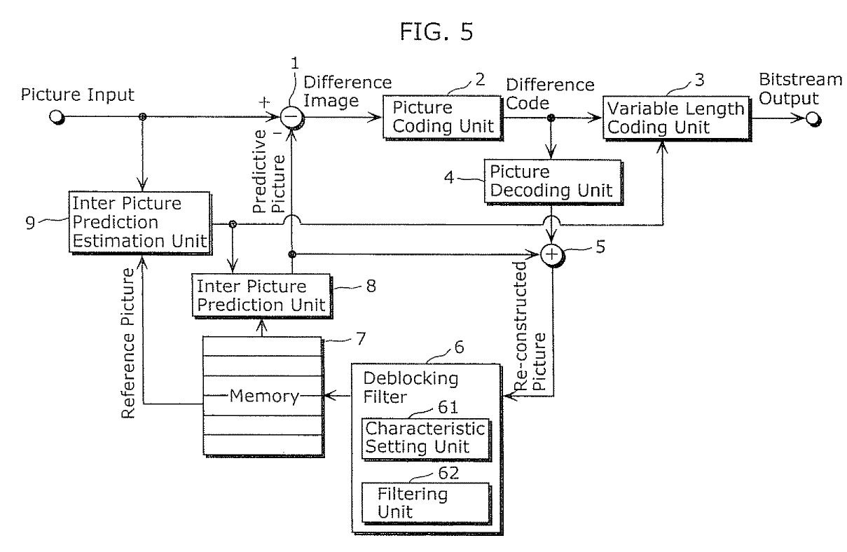

FIG. 5 is a block diagram showing a structure of the picture coding device according to the first embodiment. The picture coding device of FIG. 5 includes a subtracter 1, an picture coding unit 2, a variable length coding unit 3, an picture decoding unit 4, an adder 5, a deblocking filter 6, a memory 7, an inter picture prediction unit 8, and a picture prediction estimation unit 9.

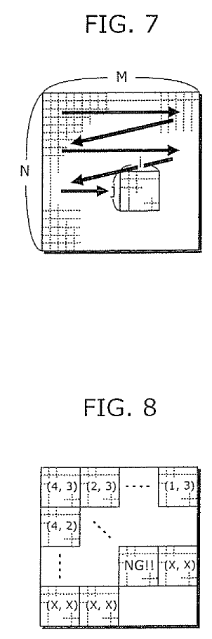

The subtracter 1 calculates difference between a predictive picture obtained from the inter picture prediction unit 8 and an input picture, on a block-by-block basis, and outputs the calculated difference as difference image. Note that the block is assumed to have i×j pixels, as shown in FIG. 7. Note also that a macroblock including such blocks is assumed to have M×N pixels, as shown in FIG. 7.

The picture coding unit 2 applies orthogonal transformation and quantization to the difference image of each block in the picture.

The variable length coding unit 3 applies variable length coding to the quantized difference image, a motion vector, coding information, and the like, in order to generate a bitstream to be outputted.

The picture decoding unit 4 applies inverse quantization and inverse orthogonal transformation to the quantized difference image inputted from the picture coding unit 2.

The adder 5 adds the difference image inputted from the picture decoding unit 4 with the predictive picture obtained from the inter picture prediction unit S, in order to generate a reconstructed picture.

The deblocking filter 6 is a device for filtering the reconstructed picture on a block-by-block basis in order to reduce distortion occurred on edges between the blocks, and also serves as a device for concealing errors of characteristics values used in the filtering. The deblocking filter 6 has a characteristic setting unit 61 and a filtering unit 62. The characteristic setting unit 61 calculates values of the characteristics (characteristic values), and conceals falsely calculated characteristic values. The filtering unit 62 filters the reconstructed picture on a block-by-block basis, by selecting a type of filtering based on the characteristic values.

The memory 7 stores the reconstructed picture filtered by the deblocking filter 6, as a reference picture.

The inter picture prediction unit 8 generates a predictive picture from the reference picture in the memory 7, using a motion vector detected by the picture prediction estimation unit 9.

The picture prediction estimation unit 9 detects the motion vector.

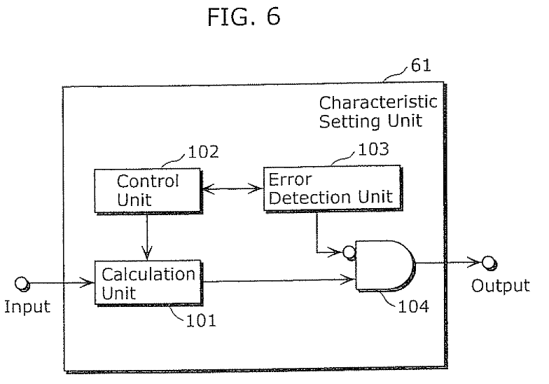

FIG. 6 is a block diagram showing a structure of the characteristic setting unit 61 in the deblocking filter 6. The characteristic setting unit 61 includes a calculation unit 101, a control unit 102, an error detection unit 103, and a mask circuit 104.

The calculation unit 101 calculates a characteristic value for each block, which actually has a set of values of boundaries (boundary values) in the block, from boundary parameters obtained from coding information (coding parameters) indicated in each macroblock.

The control unit 102 controls the calculation unit 101 to start and terminate the characteristic value calculation and to designate a location in a decoding order of a block whose boundary parameter and then characteristic value are to be calculated.

The error detection unit 103 detects errors occurred in the characteristic value calculation. For example, the error detection unit 103 detects an erroneous state of the control unit 102, when the control unit 102 is stopped (stopped state) or operates out of control (runaway state), due to calculation order violation, control algorithm violation, or the like. Further, the error detection unit 103 detects false coding information used in the calculating, by checking whether or not a value of the coding information is within a predetermined value range. Still further, the error detection unit 103 detects an erroneous characteristic value, by checking whether or not the characteristic value calculated by the calculation unit 101 is within a predetermined value range. When the error detection unit 103 detects any error, the error detection unit 103 continues to output signals indicating the error to the mask circuit 104, until the characteristic value calculation for the current macroblock including the block for which the error is detected is complete and characteristic value calculation of a next macroblock starts.

When any error is detected by the error detection unit 103, the mask circuit 104 substantially prohibits the filtering unit 62 from performing deblocking filtering, masking the erroneous characteristic value by replacing the erroneous characteristic value by a value of 0 in order to be used in the deblocking filtering. In the first embodiment, the filtering using the value of 0 means filtering without operations, in other words, processing in which deblocking filtering is not substantially applied. Note that the mask circuit 104 may, in a normal operation, output signals including the calculated characteristic value as well as an enable signal to the filtering unit 62, but when an error is detected, the mask circuit 104 may conceal the signals to disable the filtering unit 62 to perform filtering.

In the above circuit structure, the control unit 102 controls the calculation unit 101 to sequentially calculate a characteristic value used to filter block boundaries in each block having i×j pixels which is a unit smaller than a macroblock having M×N pixels. Note that, in FIG. 7, the order of filtering the blocks in the macroblock is assumed to be the same as an order of raster scanning, but generally, the order may be the same as an order of vertical sequential scanning or zig-zag scanning.

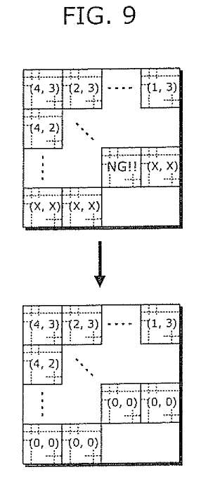

In the above-described characteristic value calculation on a block-by-block basis, when the control unit 102 is in a stopped state, or when in the operation of the control unit 102 designation of locations in decoding order of blocks is out of control due to some cause, as shown the blocks in FIG. 8, the error detecting circuit 103 detects such situation as an error. Here, there is a possibility that, after one erroneous characteristic value is calculated for one block indicated as NG in FIG. 8, the calculation unit 101 continues to generate erroneous characteristic values for other blocks positioned in decoding order subsequent to the NG block. Therefore, in order to prevent the filtering unit 62 at a later stage from performing false filtering using such erroneous characteristic values, the mask circuit 104 shown in FIG. 9 outputs values of 0 instead of the erroneous characteristic values, in order to substantially prohibit filtering of the current NG block and blocks subsequent to the NG block.

In addition, after detecting the error in the characteristic value calculation, the error detecting circuit 103 notifies the control unit 102 of the erroneous state, so that the control unit 102 can immediately restore an initial state in order to continue normal filtering for subsequent macroblocks, without affecting performance of the whole picture coding device.

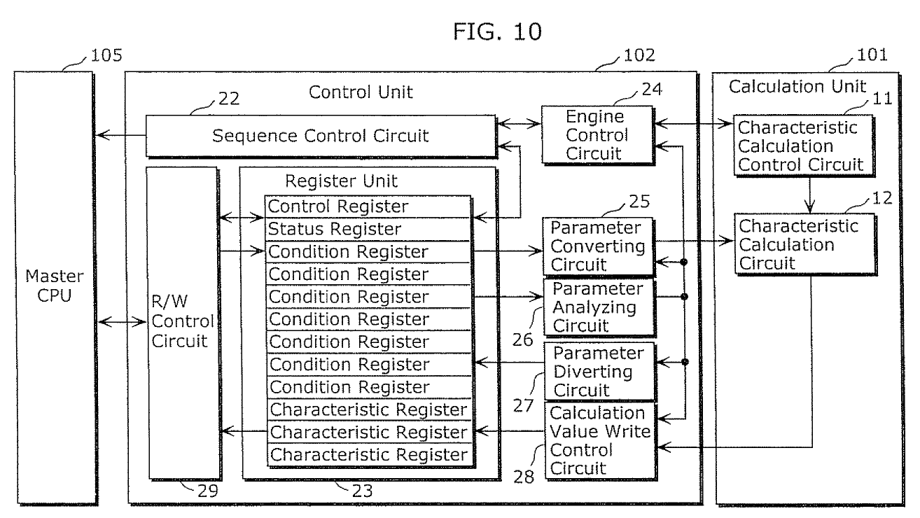

Next, the characteristic value calculation is described in more detail. FIG. 10 is a block diagram showing in detail structures of the calculation unit 101 and the control unit 102. Note that FIG. 10 also shows a master CPU 105.

The Master CPU 105 is a device for controlling the whole picture coding device, and supplies coding information regarding each macroblock to the control unit 102, and manages control operations performed by the control unit 102.

The calculation unit 101 includes a characteristic calculation control circuit 11 and a characteristic calculation circuit 12. The characteristic calculation control circuit 11 instructs the characteristic calculation circuit 12 to start and terminate the characteristic value calculation. The characteristic calculation circuit 12 calculates a characteristic value according to the instruction from the characteristic calculation control circuit 11.

The control unit 102 includes a sequence control circuit 22, a register unit 23, an engine control circuit 24, a parameter converting circuit 25, a parameter analyzing circuit 26, a parameter diverting circuit 27, a calculation value write control circuit 28, and a reading/writing (R/W) control circuit 29.

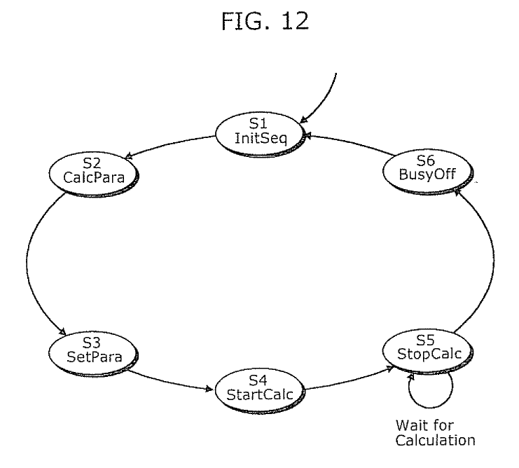

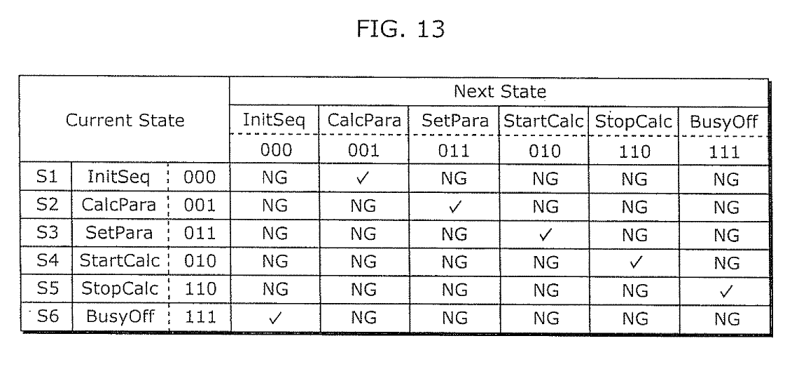

The sequence control circuit 22 changes a state of the control unit 102 to another state. It is assumed that the state of the control unit 102 includes, for example, six patterns from S1 to S6 as shown in FIG. 12. S1 is a state where, in a normal operation, a sequence of the calculation is initialized for each macroblock, S2 is a state where parameters of boundaries in a block are obtained from coding information. 53 is a state where the boundary parameters are set to a condition register. 54 is a state where the characteristic calculation control circuit 11 starts calcualation of a characteristic value (including a horizontal boundary value and a vertical boundary value) from the boundary parameters. S5 is a state where the control unit 102 waits for completion of the characteristic value calculation performed by the characteristic calculation circuit 12. S6 is a state where the characteristic value calculation is complete. The state transition is controlled by the sequence control circuit 22, according to a state transition table shown in FIG. 13. FIG. 13 shows a current state is able to go to a next state which is indicated as a symbol √.

The register unit 23 includes: a control register which holds commands, flags, and the like, inputted from the master CPU 105; a status register, as a state machine, which holds information regarding the state of the control unit 102; condition registers which hold the boundary parameters; characteristic registers which hold a characteristic value; and the like.

The engine control circuit 24 is an interface circuit serving as an interface between the sequence control circuit 22 and the characteristic calculation control circuit 11, and drives the sequence control circuit 22 and the characteristic calculation control circuit 11 depending on instructions of the characteristic calculation control circuit 11 and analyzed results of the parameter analyzing circuit 26.

The parameter converting circuit 25 converts the boundary parameters held in the condition registers to formats appropriate for the characteristic calculation circuit 12.

The parameter analyzing circuit 26 analyzes the boundary parameters held in the condition registers.

The parameter diverting circuit 27 specifies, among the boundary parameters held in the condition registers, parameters which are the same as parameters of a block to be next processed, and diverts the specified parameters to calculate a characteristic value for the next block.

The calculation value write control circuit 28 controls to write a characteristic value calculated by the characteristic calculation circuit 12 into the characteristic registers.

The R/W control circuit 29 controls reading and writing of the master CPU from and to the register unit 23.

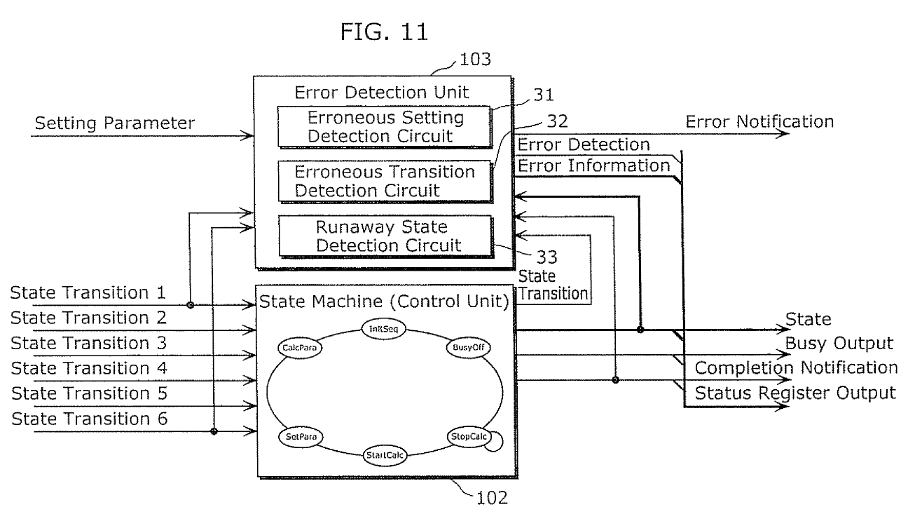

FIG. 11 is a block diagram showing in detail a structure of the error detection unit 103. Note also that FIG. 11 also shows the control unit 102 as a state machine. As shown in FIG. 11, the error detection unit 103 includes an erroneous setting detection circuit 31, an erroneous transition detection circuit 32, and a runaway state detection circuit 33.

The erroneous setting detection circuit 31 detects false values of various information in the calculation. For example, the erroneous setting detection circuit 31 detects erroneous boundary parameters by checking whether or not each value of the boundary parameters held in the condition register is within a predetermined value range. Further, the erroneous setting detection circuit 31 detects an erroneous characteristic value by checking whether or not the characteristic value held in the characteristic register is within a predetermined value range. Still further, the erroneous setting detection circuit 31 detects an erroneous command by checking whether or not the command held in the control register is one of predetermined commands.

The erroneous transition detection circuit 32 detects false state transition of the control unit 102, by checking, in each updating of the state register, whether nor not the state transition is normal, in other words, whether or not the sate transition conforms to the indication in FIG. 13.

The runaway state detection circuit 33 detects an erroneous operation of the control unit 102. More specifically, the runaway state detection circuit 33 is a watch dog timer which is reset in every state transition, and detects a stopped state or a runaway state of the control unit 102, when the current state does not go to a next state after passing a time period which is a threshold value.

As described above, according to the first embodiment, when the coding information used in the characteristic value calculation for deblocking filtering is not correct, or when the control unit 102 goes into a stopped state or a runaway state due to an internal cause such as false control algorithm or an external cause such as a noise, so such erroneous coding information or erroneous state of the control unit 102 is detected to be concealed immediately after the detection, and then the state of the control unit 102 is restored to a normal state to process a next macroblock, so that it is possible to prevent almost deterioration of image quality of the resulting decoded picture, ensuring performance of the picture coding device.

Note that the first embodiment has described that the filtering characteristic error concealing apparatus (deblocking filter 6) is used in the picture coding device of FIG. 5, but the concealing apparatus may be also used in a picture decoding device. In such a case, the picture decoding device may have a structure which differs from the structure of FIG. 5 in that the subtracter 1, the picture coding unit 2, the variable length coding unit 3, the picture prediction estimation unit 9 in FIG. 5 are replaced by a variable length decoding unit.

Note also that the first embodiment has described that the mask circuit 104 may disable the filtering unit 62 to filter when an error is detected, but the mask circuit 104 may enable the filtering unit 62 to filter by outputting (1) an alternative value, for example, a value of 0 instead of the erroneous characteristic value. Here, (1) the alternative value may indicate the weakest filter strength.

### Second Embodiment

A picture coding device of the second embodiment differs from the picture coding device of the first embodiment shown in FIG. 5 in that the characteristic setting unit 61 of FIG. 5 is replaced by a characteristic setting unit 611. Other elements in the picture coding device of the second embodiment are the same as the elements in the picture coding device of the first embodiment, so that those same name units are not described again below, but the different elements are mainly described.

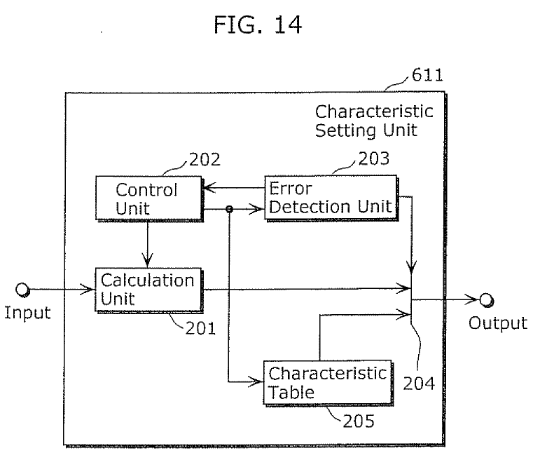

FIG. 14 is a block diagram showing a structure of the characteristic setting unit 611 in the filtering characteristic error concealing apparatus (deblocking filter 6) according to the second embodiment. The characteristic setting unit 611 includes a calculation unit 201, a control unit 202, an error detection unit 203, a selector 204, and a characteristic table 205. Note that the structure of the characteristic setting unit 611 differs from the structure of the characteristic setting unit 61 in FIG. 6 in that the mask circuit 104 is replaced by the selector 204, and the characteristic table 205 is added, while other elements basically have the same functions and structures which are not described in detail again below.

In the characteristic setting unit 611, coding information regarding a current macroblock is inputted into the calculation unit 201, and using the coding information, the control unit 202 controls the calculation unit 201 to calculate a characteristic value for each block using the inputted coding information, in order to perform filtering in the filtering unit 62 using the characteristic value.

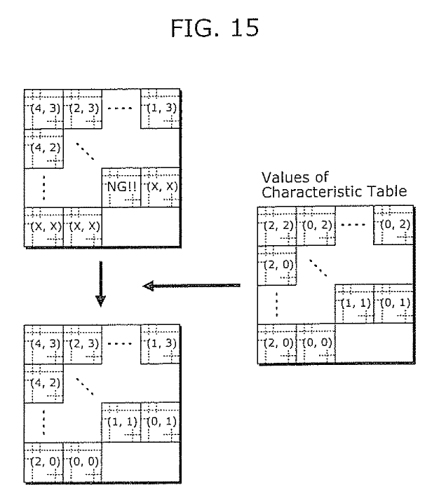

In the above-described characteristic value calculation on a block-by-block basis, when the control unit 202 is in a stopped state, or when in the operation of the control unit 202 designation of locations in decoding order of blocks is out of control due to some cause, as shown the blocks in FIG. 8, the error detecting circuit 203 detects such situation as an error. Here, there is a possibility that, after one erroneous characteristic value is calculated for one block indicated as NG in FIG. 8, the calculation unit 201 continues to generate erroneous characteristic values for other blocks positioned in decoding order subsequent to the NG block. Therefore, in order to prevent the filtering unit 62 at a later stage from performing false filtering using such erroneous characteristic values, the selector 204 sequentially selects (2) a characteristic value from the characteristic table 205 which stores representative characteristic values as shown in FIG. 15. The selected representative values are used as compensation characteristic values to compensate for the falsely calculated characteristic value and the subsequent erroneous characteristic values, in order to filter the current NG block and blocks positioned subsequent to the NG block.

In addition, after detecting the error in the characteristic value calculation, the error detecting circuit 203 notifies the control unit 202 of the erroneous state, so that the control unit 202 can immediately restore an initial state in order to continue normal filtering for subsequent macroblocks, without affecting performance of the whole picture coding device.

As described above, the filtering characteristic error concealing apparatus (deblocking filter 6) according to the second embodiment has not only effects as described in the first embodiment, but also another effect of compensating falsely-calculated characteristic values by (2) the representative characteristic values in order to be used in filtering, for a block for which an error is detected and blocks positioned in decoding order subsequent to the block, which makes it possible to prevent almost deterioration of seeming image quality of a resulting decoded picture including the macroblock in which the error occurs, without affecting performance of the whole picture coding device.

Note that the second embodiment has described that the present invention is implemented in the picture coding device, but the present invention may be also implemented in a picture decoding device.

### Third Embodiment

A picture coding device of the third embodiment differs from the picture coding device of the first embodiment shown in FIG. 5 in that the characteristic setting unit 61 of FIG. 5 is replaced by a characteristic setting unit 612. Other elements in the picture coding device of the third embodiment are the same as the elements in the picture coding device of the first embodiment, so that those same name units are not described again below, but the different elements are mainly described.

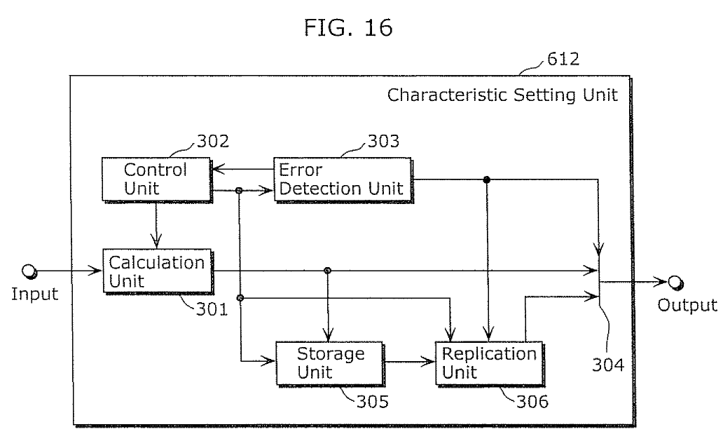

FIG. 16 is a block diagram showing a structure of the characteristic setting unit 612 in the filtering characteristic error concealing apparatus (deblocking filter 6) according to the third embodiment. The characteristic setting unit 612 includes a calculation unit 301, a control unit 302, an error detection unit 303, a selector 304, a storage unit 305, and a replication unit 306. Note that the structure of the characteristic setting unit 612 differs from the structure of the characteristic setting unit 61 in FIG. 6 in that the mask circuit 104 is replaced by the selector 304, and the storage unit 305 and the replication unit 306 are added, while other elements basically have the same functions and structures which are not described in detail again below.

In the characteristic setting unit 612, coding information regarding a current macroblock is inputted into the calculation unit 301, and using the coding information, the control unit 302 controls the calculation unit 301 to calculate a characteristic value for each block using the inputted coding information, in order to perform filtering in the filtering unit 62 using the characteristic value.

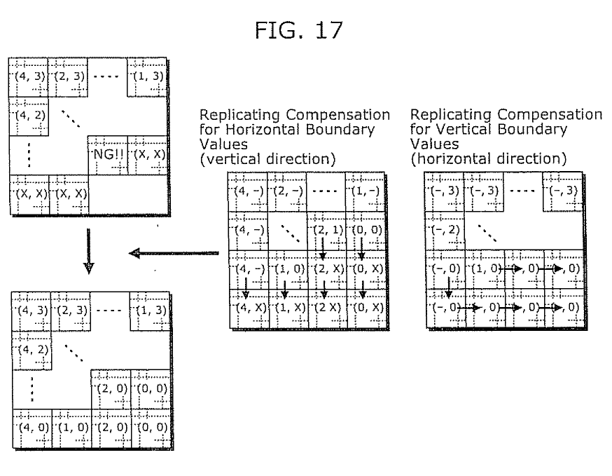

In the above-described characteristic value calculation on a block-by-block basis, when the control unit 302 is in a stopped state, or when in the operation of the control unit 202 designation of locations in decoding order of blocks is out of control due to some cause, as shown the blocks in FIG. 8, the error detecting circuit 303 detects such situation as an error Here, there is a possibility that, after one erroneous characteristic value is calculated for one block indicated as NG in FIG. 8, the calculation unit 201 continues to generate erroneous characteristic values for other blocks positioned in decoding order subsequent to the NG block. Therefore, in order to prevent the filtering unit 62 at a later stage from performing false filtering using such erroneous characteristic values, the storage unit 305 sequentially stores characteristic values which have been correctly calculated. The replication unit 306 chooses (a) a horizontal boundary value, in other words, a value for a boundary in a vertical direction filtering, from (3a) a stored characteristic value of a block adjacent to the current block, and (b) a vertical boundary value, in other words, a value for a boundary in a horizontal direction filtering, from (3b) a stored characteristic value of another block adjacent to the current block, in order to obtain one appropriate characteristic value having the chosen (a) horizontal boundary value and (b) vertical boundary value, and then replicates the obtained characteristic value, for the current block, namely, each of the NG block shown in FIG. 17 and blocks subsequent to the NG block. The replicated characteristic value of the adjacent block is more correlated with a true characteristic value of the current block compared to (2) the representative characteristic values described in the second embodiment. The selector 304 selects such replicated characteristic value rather than the falsely calculated characteristic value, and outputs each replicated characteristic value to compensate for each of the falsely calculated characteristic value and the subsequent erroneous characteristic value, in order to filter the current NG block and blocks subsequent to the NG block.

Note that characteristic setting unit 612 may perform as described below. That is, in order to perform deblocking filtering, the control unit 302 controls to obtain each replicated characteristic value of the current NG bock and blocks subsequent to the NG bock, by selecting a horizontal boundary value from (3a) a characteristic value for the adjacent block positioned immediately above the current block, and a vertical boundary value from (3b) a characteristic value for the another adjacent block positioned on the immediately left of the current block.

In addition, after detecting the error in the characteristic value calculation, the error detecting circuit 303 notifies the control unit 302 of the erroneous state, so that the control unit 302 can immediately restore an initial state in order to continue normal filtering for subsequent macroblocks, without deteriorating performance of the whole picture coding device.

As described above, the filtering characteristic error concealing apparatus (deblocking filter 6) according to the third embodiment has not only effects as described in the first embodiment, but also another effect of sequentially replicating characteristic values from (3a, 3c) already-calculated correct characteristic values for blocks which are adjacent to the current blocks in the same macroblock, thereby compensating falsely-calculated characteristic values by the replicated characteristic values in order to be used in deblocking filtering, for the block for which an error is detected and blocks positioned in decoding order subsequent to the block with error, which makes it possible to prevent almost deterioration of seeming image quality of a resulting decoded picture including the macroblock in which the error occurs, without affecting performance of the whole picture coding device.

Note that the third embodiment has described that the present invention is implemented in the picture coding device, but the present invention may be also implemented in a picture decoding device.

### Fourth Embodiment

A picture coding device of the fourth embodiment differs from the picture coding device of the first embodiment shown in FIG. 5 in that the characteristic setting unit 61 of FIG. 5 is replaced by a characteristic setting unit 613. Other elements in the picture coding device of the fourth embodiment are the same as the elements in the picture coding device of the first embodiment, so that those same name units are not described again below, but the different elements are mainly described.

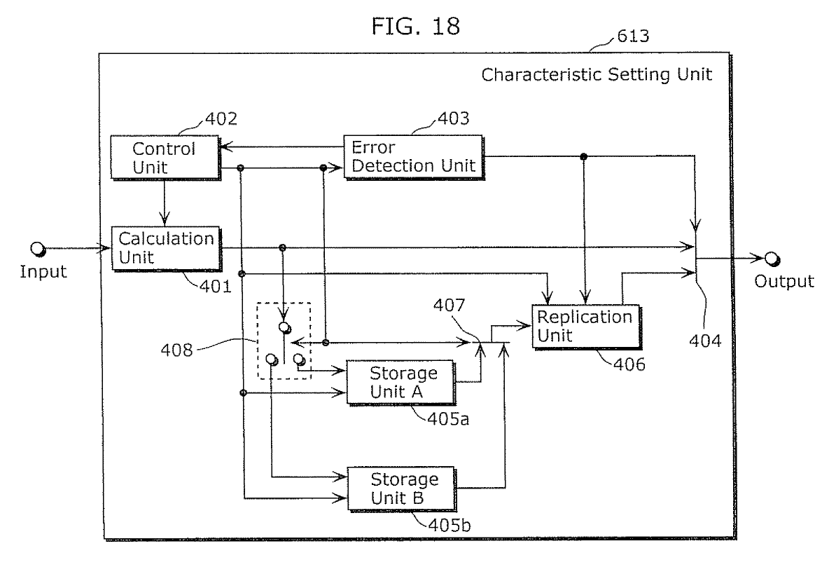

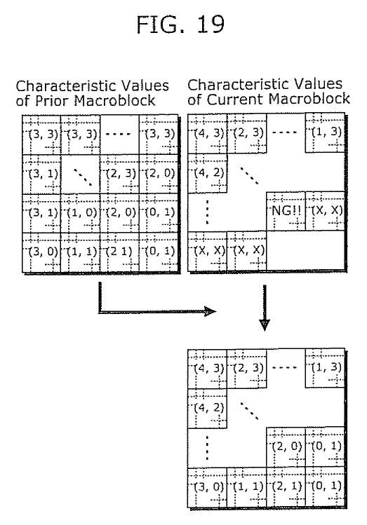

FIG. 18 is a block diagram showing a structure of the characteristic setting unit 613 in the filtering characteristic error concealing apparatus (deblocking filter 6) according to the fourth embodiment. The characteristic setting unit 613 includes a calculation unit 401, a control unit 402, an error detection unit 403, a selector 404, a storage unit A 405a, a storage unit B 405b, a replication unit 406, a selector 407, and a selector 408. Note that the structure of the characteristic setting unit 613 differs from the structure of the characteristic setting unit 61 in FIG. 6 in that the mask circuit 104 is replaced by the selector 404, and the storage unit A 405a, the storage unit B 405b, the replication unit 406, and the selector 407 are added, while other elements basically have the same functions and structures which are not described in detail again below.

In the characteristic setting unit 613, coding information regarding a current macroblock is inputted into the calculation unit 401, and using the coding information, the control unit 402 controls the calculation unit 401 to calculate a characteristic value for each block using the inputted coding information, in order to perform filtering in the filtering unit 62 using the characteristic value.

In the above-described characteristic value calculation on a block-by-block basis, as shown in FIG. 18, the storage unit A 405a sequentially stores characteristic values which are calculated for blocks in a current macroblock to be coded, and when the macroblock to be coded is changed to a macroblock positioned in decoding order on the immediately right of the macroblock, the storage unit B 405b sequentially stores characteristic values which are calculated for blocks in this next current macroblock. Note that each of the storage unit A 405a and the storage unit B 405b has a capacity for storing characteristic values for one macroblock, and after storing of the characteristic values for one macroblock and further storing of characteristic values for another macroblock by another storage unit, the storage unit overwrites subsequent characteristic values for subsequent one macroblock onto the already-stored characteristic values. By repeating the above processing, in the storage unit A 405a and the storage unit B 405b, there are characteristic values of blocks in a current macroblock and characteristic values of blocks in a macroblock positioned in the immediately left of the current macroblock.

Here, when the control unit 402 is in a stopped state, or when in the operation of the control unit 402 designation of locations in decoding order of blocks is out of control due to some cause, as shown the blocks in FIG. 8, the error detecting circuit 403 detects such situation as an error. In this case, there is a possibility that, after one erroneous characteristic value is calculated for one block indicated as NG in FIG. 8, the calculation unit 401 continues to generate erroneous characteristic values for other blocks positioned in decoding order subsequent to the NG block. Therefore, in order to prevent the filtering unit 62 at a later stage from performing false filtering using such erroneous characteristic values, the selector 407 selects characteristic values which are stored in the storage unit A 405a or the storage unit B 405b and which are for blocks in a macroblock immediately prior to the current macroblock, and then the replication unit 406 chooses, for each of the NG block and other blocks subsequent to the NG block, (4b) a characteristic value from the selected characteristic values for a block which is included in decoding order in the prior macroblock and which is positioned in the prior macroblock at the same location as the current block, and replicated the chosen characteristic value. The replicated characteristic value is correlated with a true characteristic value for the current block. The selector 404 selects such replicated characteristic value rather than the falsely calculated characteristic value, and outputs each replicated characteristic value to compensate for each of the falsely calculated characteristic value and the subsequent erroneous characteristic values, in order to filter the current NG block and blocks subsequent to the NG block.

Note that the above-described selecting of the selection circuit 407 may be performed by the control unit 402 as described below. That is, in order to perform deblocking filtering, the control unit 402 compares (3) a characteristic value for a block which is in the current macroblock and positioned adjacent to the current block, with (4b) a characteristic value of a block which is included in the prior macroblock and which is positioned in the prior macroblock at the same location as the current block. If the compared characteristic values are same, then (4b) the characteristic value for the block in the prior macroblock is read out from the storage unit. On the other hand, if the compared characteristic values are not the same, then (3) the characteristic value for the adjacent block in the current macroblock is read out from the storage unit. The readout characteristic value is replicated to be used for deblocking filtering. Note that the control unit 402 may compare the horizontal boundary values in the characteristic values (3) and (4b), and also compare the vertical boundary values in the characteristic values (3) and (4b), in order to be read out in the same conditions as described above. Then the replication unit 406 may replicate, for one compensation value, the read-out horizontal boundary value and the read-out vertical boundary value.

In addition, after detecting the error in the characteristic value calculation, the error detecting circuit 403 notifies the control unit 402 of the erroneous state, so that the control unit 402 can immediately restore an initial state in order to continue normal filtering for subsequent macroblocks, without deteriorating performance of the whole picture coding device.

As described above, the filtering characteristic error concealing apparatus (deblocking filter 6) according to the fourth embodiment has not only effects as described in the first embodiment, but also another effect of sequentially selecting, from the storage unit, a more appropriate characteristic value, from (3) a characteristic value for a block which is in the current macroblock and positioned adjacent to the current block, and (4b) a characteristic value for a block which is included in the prior macroblock and positioned in the prior macroblock at the same location as the current block, then replicating the selected characteristic value to compensate for falsely-calculated characteristic value, thereby filtering is performed using the compensated characteristic value of a macroblock which is correlated with the current block, for each of a block for which an error is detected and blocks positioned in decoding order subsequent to the block with error, which makes it possible to prevent almost deterioration of seeming image quality of a resulting decoded picture including the macroblock in which the error occurs, without affecting performance of the whole picture coding device.

Note that the fourth embodiment has described that the present invention is implemented in the picture coding device, but the present invention may be also implemented in a picture decoding device.

### Fifth Embodiment

A picture coding device of the fifth embodiment differs from the picture coding device of the first embodiment shown in FIG. 5 in that the characteristic setting unit 61 of FIG. 5 is replaced by a characteristic setting unit 614. Other elements in the picture coding device of the fifth embodiment are the same as the elements in the picture coding device of the first embodiment, so that those same name units are not described again below, but the different elements are mainly described.

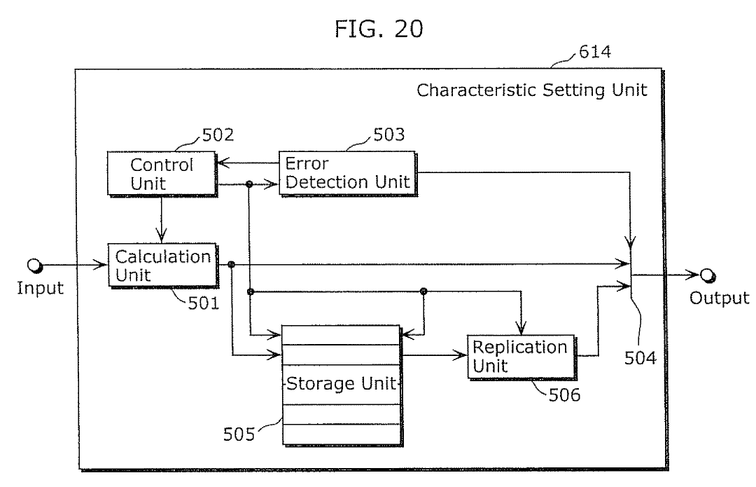

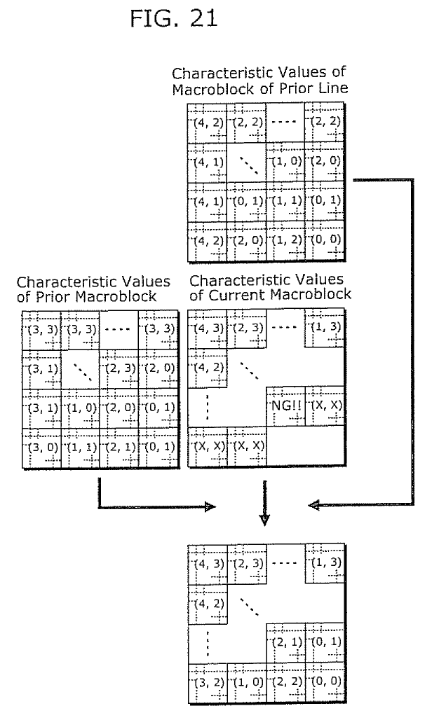

FIG. 20 is a block diagram showing a structure of the characteristic setting unit 614 in the filtering characteristic error concealing apparatus (deblocking filter 6) according to the fifth embodiment. The characteristic setting unit 614 includes a calculation unit 501, a control unit 502, an error detection unit 503, a selector 504, a storage unit 505, and a replication unit 506. Note that the structure of the characteristic setting unit 614 differs from the structure of the characteristic setting unit 61 in FIG. 6 in that the mask circuit 104 is replaced by the selector 504, and the storage unit 505 and the replication unit 506 are added, while other elements basically have the same functions and structures which are not described in detail again below.

In the characteristic setting unit 614, coding information regarding a current macroblock is inputted into the calculation unit 501, and using the coding information, the control unit 502 controls the calculation unit 501 to calculate a characteristic value for each block using the inputted coding information, in order to perform filtering in the filtering unit 62 using the characteristic value.

In the above-described characteristic value calculation on a block-by-block basis, as shown in FIG. 20, characteristic values of blocks in a current macroblock to be coded are sequentially stored into the storage unit 505. This storage unit 505 has a capacity for storing characteristic values for blocks included in sequential macroblocks whose number is equal to the number of macroblocks in one macroblock line and which are followed in decoding order by a current macroblock, and after storing the characteristic values for the sequential macroblocks, the storage unit 505 sequentially overwrites characteristic values for macroblocks in next one macroblock line onto the already-stored characteristic values. By repeating the above processing, in the storage unit 505, there are characteristic values for a current macroblock, characteristic values for a macroblock positioned on the immediately left of the current macroblock, and characteristic values for a macroblock positioned immediately above the current macroblock.

Here, when the control unit 502 is in a stopped state, or when in the operation of the control unit 502 designation of locations in decoding order of blocks is out of control due to some cause, as shown the blocks in FIG. 8, the error detecting circuit 503 detects such situation as an error. In this case, there is a possibility that, after one erroneous characteristic value is calculated for one block indicated as NG in FIG. 8, the calculation unit 501 continues to generate erroneous characteristic values for other blocks positioned in decoding order subsequent to the NG block. Therefore, in order to prevent the filtering unit 62 at a later stage from performing false filtering using such erroneous characteristic values, the storage unit 505 outputs (4a) horizontal boundary values of characteristic values for blocks included in a macroblock which is positioned immediately above the current macroblock, and (4b) vertical boundary values of characteristic values for blocks included in another macroblock which is positioned on the immediately left of the current macroblock. The replication unit 506 chooses, from the outputted characteristic values, (a) a horizontal boundary value of (4a) a characteristic value for a block which is included in the above macroblock and positioned in the above macroblock at the same location of the current block, and (b) a vertical boundary value of (4b) a characteristic value for a block which is included in the left macroblok and positioned in the left macroblock at the same location of the current block, in order to obtain a characteristic value having the selected horizontal and vertical boundary values (a) and (b), and then replicates the obtain characteristic value for the current block, namely, each of the NG block and blocks subsequent to the NG block. The replicated characteristic value of the blocks in the adjacent macrobloks (3) is strongly correlated with a true characteristic value of the current block in the current macroblock. The selector 504 selects such replicated characteristic value rather than the falsely calculated characteristic value, and outputs each replicated characteristic value to compensate for each of the falsely calculated characteristic value and the subsequent erroneous characteristic values, in order to filter the current NG block and blocks subsequent to the NG block.

Note that the control unit 502 may replicate the characteristic values from the storage unit 505 as described below. That is, for a block for which an error is detected and other blocks subsequent to the block, the storage unit 505 compares (3) a characteristic value of a block which is in the current macroblock and positioned adjacent to the current block, (4b) a characteristic value of a block which is in an adjacent macroblock positioned immediately above the current macroblock and which is positioned in the adjacent macroblock at the same location as the current block, and (4a) a characteristic value of a block which is in another adjacent macroblock positioned on the immedicately left of the current macroblock and which is positioned at in the another adjacent macroblock the same location as the current block. If the characteristic value (3) is the same as the characteristic values (4a) and (4b), then the characteristic values (4a) and (4c), which includes both of a horizontal boundary value and a vertical boundary value, are outputted. On the other hand, if the characteristic value (3) is not the same as the characteristic value (4a) nor (4b), then (3) the characteristic value, which includes both of a horizontal boundary value and a vertical boundary value, is outputted. The output characteristic value is replicated to be used for deblocking filtering. Note that the control unit 502 may compare the horizontal boundary value in the characteristic value (3) with the horizontal boundary values in the characteristic values (4a) and (4b), and also compare the vertical boundary value in the characteristic value (3) with the vertical boundary values in the characteristic values (4a) and (4b), in order to be read out in the same conditions as described above. Then the replication unit 506 may replicate, for one compensation value, the read-out horizontal boundary value and the read-out vertical boundary value.

In addition, after detecting the error in the characteristic value calculation, the error detecting circuit 503 notifies the control unit 402 of the erroneous state, so that the control unit 502 can immediately restore an initial state in order to continue normal filtering for subsequent macroblocks, without deteriorating performance of the whole picture coding device.

As described above, the filtering characteristic error concealing apparatus (deblocking filter 6) according to the fifth embodiment has not only effects as described in the fourth embodiment, but also another effect of sequentially selecting, from the storage unit, (a) a horizontal vertical boundary value of (4a) a characteristic value for a block which is included in an adjacent macroblok positioned immediately above the current macroblock and which is positioned in the above macroblock at the same location as the current block, and (b) a vertical boundary value of (4b) a characteristic value for a block which is included in another is adjacent macroblock positioned on the immediately left of the current macroblock and which is positioned in the left macroblock at the same location as the current block, in order to output a characteristic value having the selected horizontal and vertical boundary values (a) and (b), then sequentially replicating the output characteristic value in order to compensate for the falsely-calculated characteristic value of the current block, namely, each of a block for which an error is detected and blocks positioned in decoding order subsequent to the block. This makes it possible to filter each of a block for which an error is detected and blocks subsequent to the block, using each characteristic value having a horizontal boundary value and a vertical value, each of which is independently correlated with a horizontal boundary value and a vertical boundary value of a true characteristic value of the current block. This makes it possible to prevent almost deterioration of seeming image quality of a resulting decoded picture including the macroblock in which the error occurs, without affecting performance of the whole picture coding device.

Note that the replication unit 506 may select, for each of a block for which an error is detected and other blocks subsequent to the block, characteristic values, by calculating an average value, a maximum value, or a minimum values, from (4a, 4b) characteristic values for both blocks, which are positioned both in the adjacent macroblocks positioned in the immediately left of and immediately above the current macroblok, and which are positioned at the same location as the current block, and replicate the calculated value,

Note also that the replication unit 506 may generate, for each of a block for which an error is detected and other blocks subsequent to the block, a characteristic value, by selecting, (a) a horizontal boundary value of (4a) a characteristic value for a block which is included in the adjacent macroblok positioned immediately above the current macroblock and which is positioned in the above macroblock at the same location as the current block, and (b) a vertical boundary value of (4b) a characteristic value for a block which is included in the adjacent macroblock positioned on the immediately left of the current macroblock and which is positioned in the left macroblock at the same location as the current block, in order to obtain a characteristic value having the selected horizontal and vertical boundary values (a) and (b), and then replicate the obtained values.

Note that the fifth embodiment has described that the present invention is implemented in the picture coding device, but the present invention may be also implemented in a picture decoding device.

### Sixth Embodiment

A picture coding device of the sixth embodiment differs from the picture coding device of the first embodiment shown in FIG. 5 in that the characteristic setting unit 61 of FIG. 5 is replaced by a characteristic setting unit 615. Other elements in the picture coding device of the sixth embodiment are the same as the elements in the picture coding device of the first embodiment, so that those same name units are not described again below, but the different elements are mainly described.

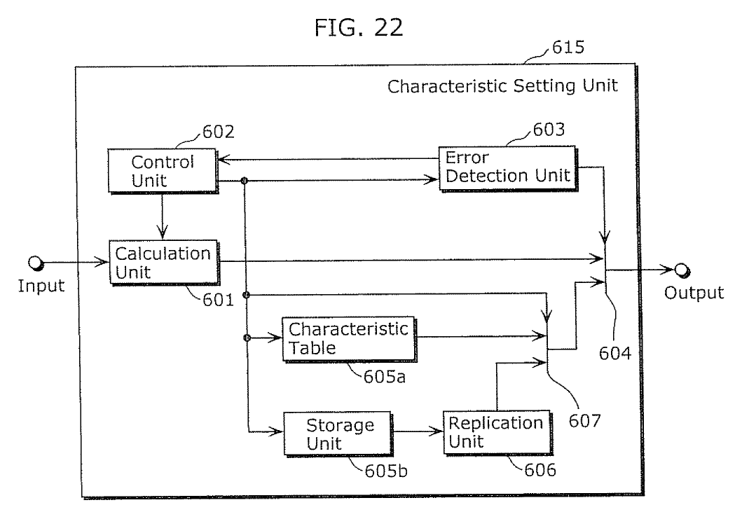

FIG. 22 is a block diagram showing a structure of the characteristic setting unit 65 in the filtering characteristic error concealing apparatus (deblocking filter 6) according to the sixth embodiment. The characteristic setting unit 615 includes a calculation unit 601, a control unit 602, an error detection unit 603, a selector 604, a characteristic table 605a, a storage unit 605b, a replication unit 606, and a selector 607. Note that the structure of the characteristic setting unit 615 differs from the structure of the characteristic setting unit 61 in FIG. 6 in that the mask circuit 104 is replaced by the selector 604, and the characteristic table 605a, the storage unit 605b, the replication unit 606, and the further selector 607 are added, while other elements basically have the same functions and structures which are not described in detail again below.

In the characteristic setting unit 615, coding information regarding a current macroblock is inputted into the calculation unit 601, and using the coding information, the control unit 602 controls the calculation unit 601 to calculate a characteristic value for each block using the inputted coding information, in order to perform filtering in the filtering unit 62 using the characteristic value.

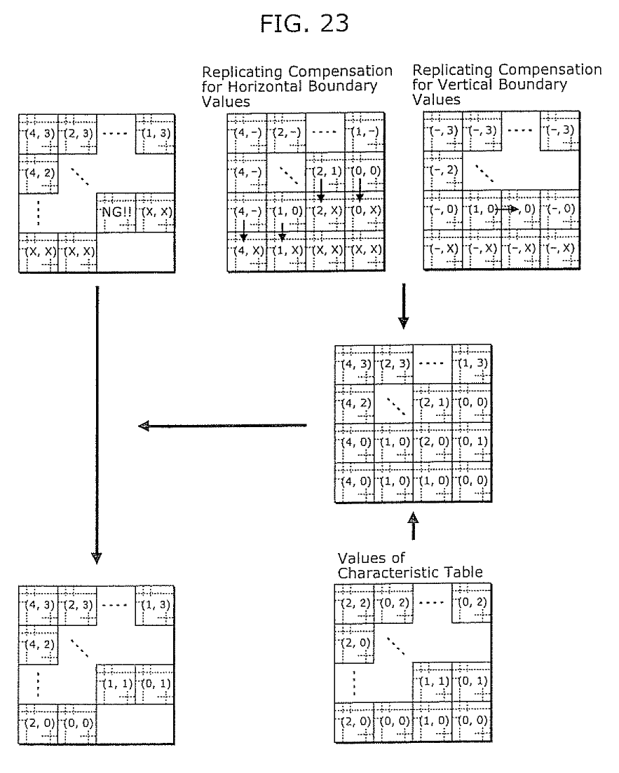

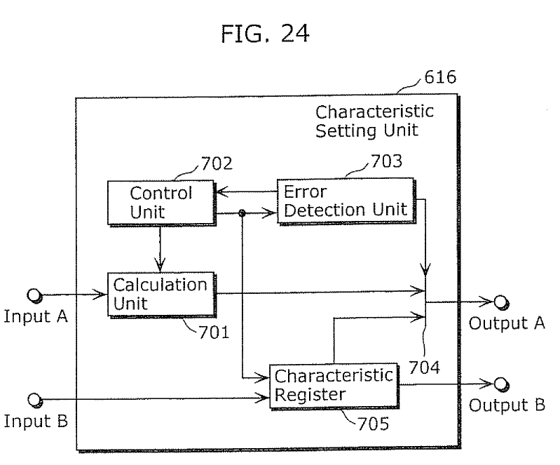

In the above-described characteristic value calculation on a block-by-block basis, when the control unit 602 is in a stopped state, or when in the operation of the control unit 602 designation of locations in decoding order of blocks is out of control due to some cause, as shown the blocks in FIG. 8, the error detecting circuit 603 detects such situation as an error. Here, there is a possibility that, after one erroneous characteristic value is calculated for one block indicated as NG in FIG. 8, the calculation unit 601 continues to generate erroneous characteristic values for other blocks positioned in decoding order subsequent to the NG block. Therefore, in order to prevent the filtering unit 62 at a later stage from performing false filtering using such erroneous characteristic values, as shown in FIG. 22, the storage unit 305b sequentially stores characteristic values which have been correctly calculated. Next, if the storage unit 605a stores (3a) a characteristic value for an adjacent block which is positioned immediately above of the current block and (3b) a characteristic value for another adjacent block which is positioned on the immediately left of the current block, then the replication unit 606 chooses (a) a horizontal boundary value from (3a or 3b) the stored characteristic value for one of the adjacent blocks and (b) a vertical boundary value from (3a or 3b) the stored characteristic value for another adjacent block, in order to obtain one appropriate characteristic value having the chosen horizontal and vertical boundary values (a) and (b), and then replicates the obtain characteristic value for the current block, namely, each of the NG block shown in FIG. 23 and blocks subsequent to the NG block. On the other hand, if the storage unit 605a not stores (3a) a characteristic value for another adjacent block which is positioned immediately above of the current block nor (3b) a characteristic value for an adjacent block which is positioned on the immediately left of the current block, the characteristic table 605a outputs (2) a representative characteristic value, which is positioned in the table at the same location as the current block, in order to be used for filtering the current block, namely, each of the NG block shown in FIG. 23 and blocks subsequent to the NG block. Thus, depending on whether or not (3) characteristic values for blocks adjacent to the current block have already been calculated and stored, the selector 607 selects a compensation value outputted from the replication unit 606 or a compensation value outputted from the characteristic table. Then, when an error occurs, the selector 604 further selects the compensation value selected by the selector 707, rather than an erroneous characteristic value calculated by the calculation unit 601, in order to compensate the erroneous characteristic value by the compensation value which is appropriate more that the erroneous characteristic value, to perform filtering.

In addition, after detecting the error in the characteristic value calculation, the error detecting circuit 603 notifies the control unit 602 of the erroneous state, so that the control unit 602 can immediately restore an initial state in order to continue normal filtering for subsequent macroblocks, without deteriorating performance of the whole picture coding device.

As described above, the filtering characteristic error concealing apparatus (deblocking filter 6) according to the sixth embodiment has not only effects as described in the second and third embodiments, but also another effect of, when (4) characteristic values for blocks in the current macroblock which are adjacent to the current block have been already calculated, replicating the values to obtain an appropriate value to compensate for a falsely calculated characteristic value, and on the other hand, when (3) characteristic values for blocks in the current macroblock which are adjacent to the current block have not been already calculated, obtaining (2) a representative value to compensate for a falsely calculated characteristic value, in order to filter the current block, namely, each of a block for which an error is detected and blocks subsequent to the block, using a characteristic value which can be selected from (2) values in the characteristic table or from (3) values for the adjacent blocks, and whose gap between a true characteristic value is less compared to the compensation value described in the second and third embodiments which is not able to be selected from (2) values in the characteristic table or from (3) values for the adjacent blocks. This makes it possible to prevent almost deterioration of seeming image quality of a resulting decoded picture including the macroblock in which the error occurs, without affecting performance of the whole picture coding device.

Note that the characteristic setting unit 615 may obtain the compensation value, when (3) characteristic values for adjacent blocks are not stored, by calculating an average value of a characteristic value stored in the characteristic table 605a and a characteristic value stored in the storage unit 605b for the blocks nearest to the current block, in order to be used for deblockng filtering.

Note that the sixth embodiment has described that the present invention is implemented in the picture coding device, but the present invention may be also implemented in a picture decoding device.

### Seventh Embodiment

A picture coding device of the seventh embodiment differs from the picture coding device of the first embodiment shown in FIG. 5 in that the characteristic setting unit 61 of FIG. 5 is replaced by a characteristic setting unit 616. Other elements in the picture coding device of the seventh embodiment are the same as the elements in the picture coding device of the first embodiment, so that those same name units are not described again below, but the different elements are mainly described.

FIG. 24 is a block diagram showing a structure of the characteristic setting unit 616 in the filtering characteristic error concealing apparatus (deblocking filter 6) according to the seventh embodiment. The characteristic setting unit 616 includes a calculation unit 701, a control unit 702, an error detection unit 703, a selector 704, and a characteristic register 705. Note that the structure of the characteristic setting unit 616 differs from the structure of the characteristic setting unit 61 in FIG. 6 in that the mask circuit 104 is replaced by the selector 704, and the characteristic register 705 is added, while other elements basically have the same functions and structures which are not described in detail again below.

In the characteristic setting unit 616, coding information regarding a current macroblock is inputted into the calculation unit 701, and using the coding information, the control unit 702 controls the calculation unit 701 to calculate a characteristic value for each block using the inputted coding information, in order to perform filtering in the filtering unit 62 using the characteristic value.

In the above-described characteristic value calculation on a block-by-block basis, when the control unit 702 is in a stopped state, or when in the operation of the control unit 702 designation of locations in decoding order of blocks is out of control due to some cause, as shown the blocks in FIG. 8, the error detecting circuit 703 detects such situation as an error. Here, there is a possibility that, after one erroneous characteristic value is calculated for one block indicated as NG in FIG. 8, the calculation unit 701 continues to generate erroneous characteristic values for other blocks positioned in decoding order subsequent to the NG block. Therefore, in order to prevent the filtering unit 62 at a later stage from performing false filtering using such erroneous characteristic values, the characteristic register 705 previously stores characteristic values as shown in FIG. 15 by a microcomputer or a digital signal processor (DSP), and the selector 704 selects a characteristic value outputted from the characteristic register 705 rather than an erroneous characteristic value calculated by the calculation unit 701, in order to compensate for the falsely calculated value by the selected value, to be used to filter the current block, namely, each of the NG block and blocks subsequent to the NG block. The control unit 702 updates the characteristic register 705, on a macroblock-by-macroblock basis, on a slice-by-slice basis, or on a picture-by-picture basis Note also that the written compensation values can be updated anytime at an arbitrary timing.

In addition, after detecting the error in the characteristic value calculation, the error detecting circuit 703 notifies the control unit 702 of the erroneous state, so that the control unit 702 can immediately restore an initial state in order to continue normal filtering for subsequent macroblocks, without deteriorating performance of the whole picture coding device.

As described above, the filtering characteristic error concealing apparatus (deblocking filter 6) according to the seventh embodiment has not only effects as described in the second embodiment, but also another effect of, updating (2′) representative characteristic values at any time on a slice-by-slice basis, a picture-by-picture basis, for example, thereby compensating for a falsely calculated characteristic value by (2′) the representative value which is closer to a true characteristic value of the current block compare to (2) the fixed value described in the second embodiment, in order to used to filter the current block, namely, each of the block for which the error is detected and blocks subsequent to the block. This makes it possible to prevent almost deterioration of seeming image quality of a resulting decoded picture including the macroblock in which the error occurs, without affecting performance of the whole picture coding device.

Note that the seventh embodiment has described that the present invention is implemented in the picture coding device, but the present invention may be also implemented in a picture decoding device.

### Eighth Embodiment

A picture coding device of the eighth embodiment differs from the picture coding device of the first embodiment shown in FIG. 5 in that the characteristic setting unit 61 of FIG. 5 is replaced by a characteristic setting unit 617. Other elements in the picture coding device of the eighth embodiment are the same as the elements in the picture coding device of the first embodiment, so that those same name units are not described again below, but the different elements are mainly described.

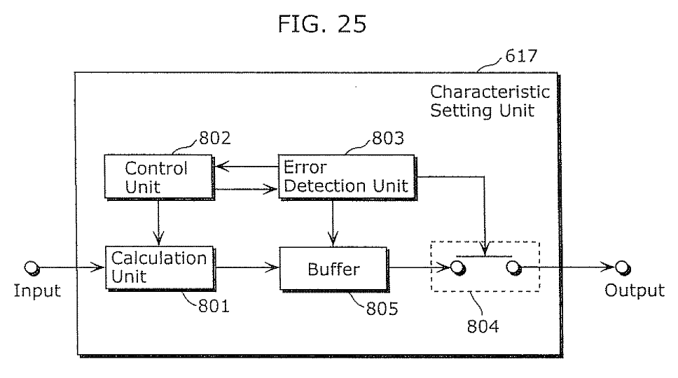

FIG. 25 is a block diagram showing a structure of the characteristic setting unit 617 in the filtering characteristic error concealing apparatus (deblocking filter 6) according to the eighth embodiment. The characteristic setting unit 617 includes a calculation unit 805, a control unit 802, an error detection unit 803, a switch 804, and a buffer 805. Note that the structure of the characteristic setting unit 617 differs from the structure of the characteristic setting unit 61 in FIG. 6 in that the mask circuit 104 is replaced by the switch 804, and the buffer 805 is added, while other elements basically have the same functions and structures which are not described in detail again below.

In the characteristic setting unit 617, coding information regarding a current macroblock is inputted into the calculation unit 601, and using the coding information, the control unit 802 controls the calculation unit 801 to calculate a characteristic value for each block using the inputted coding information, in order to perform filtering in the filtering unit 62 using the characteristic value.

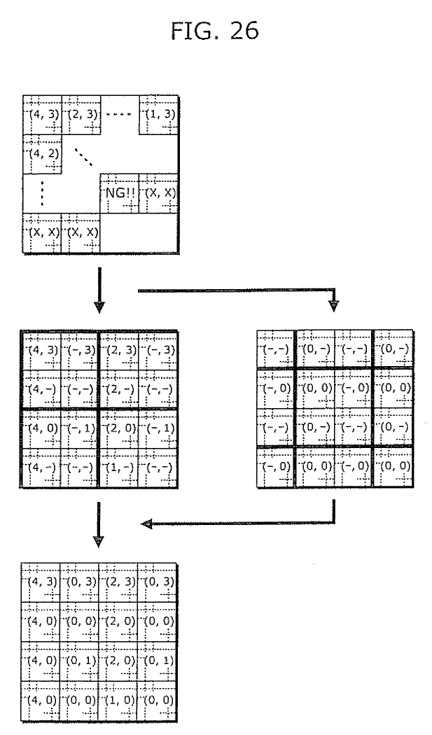

In the above-described characteristic value calculation on a block-by-block basis, when the control unit 802 is in a stopped state, or when in the operation of the control unit 802 designation of locations in decoding order of blocks is out of control due to some cause, as shown the blocks in FIG. 8, the error detecting circuit 803 detects such situation as an error. Here, there is a possibility that, after one erroneous characteristic value is calculated for one block indicated as NG in FIG. 8, the calculation unit 801 continues to generate erroneous characteristic values for other blocks positioned in decoding order subsequent to the NG block. Therefore, in order to prevent the filtering unit 62 at a later stage from performing false filtering using such erroneous characteristic values, the buffer 805 temporarily stores a characteristic value calculated for each block, without outputting the characteristic value directly from the calculation unit 801. When an error is detected as described above, the characteristic value stored in the buffer 805 is deleted, and the control unit 802 outputs a signal instructing the calculation unit 801 to re-calculate a characteristic value for the current block. In the re-calculation, in order to reduce influence to performance of the whole picture coding device, a characteristic value is calculated for a boundary of a sub-macroblock obtained when segmenting the current macroblock into four sub-macroblocks as shown in FIG. 26, while a characteristic value for a boundary which is not a boundary of the sub-macroblock is not calculated, but masked by a value of 0 or compensated by (2) a representative characteristic value. The characteristic value obtained as described above is stored into the buffer 805 again. When the first and second characteristic value calculation completes for the NG block to an end block in the current macroblock, the switch 804 is turned ON to output the secondary-calculated characteristic values to the filtering unit 62.

Note that, when the error is detected, the characteristic setting unit 617 may perform the secondary calculation of characteristic value, by firstly estimating an idle time (idle cycle number) until start of next characteristic value calculation for a next macroblock, and then limiting the blocks and boundaries to be secondary calculated, so that the secondary calculation completes within the idle time.

As described above, the filtering characteristic error concealing apparatus (deblocking filter 6) according to the eighth embodiment has not only effects as described in the second and third embodiments, but also another effect of, when an error occurs in the characteristic value calculation, limiting boundaries to be filtered and re-calculating characteristic values for the limited boundaries. This makes it possible to prevent almost deterioration of seeming image quality of a resulting decoded picture including the macroblock in which the error occurs, without affecting performance of the whole picture coding device.

Note that the eighth embodiment has described that the present invention is implemented in the picture coding device, but the present invention may be also implemented in a picture decoding device.

Although only some exemplary embodiments of the present invention have been described in detail above, those skilled in the art will be readily appreciate that many modifications are possible in the exemplary embodiments without materially departing from the novel teachings and advantages of the present invention. Accordingly, all such modifications are intended to be included within the scope of this invention.

### INDUSTRIAL APPLICABILITY

As described above, the filtering characteristic error concealing apparatus, a picture coding device, a picture decoding device, and a filtering characteristic error concealing method according to the present invention are suitable for an apparatus, such as a portable telephone, a DVD apparatus, or a digital TV apparatus, for performing coding of a picture to generate a code sequence, decoding of the generated code sequence, and other processing.

What is claimed is:

1. A filtering characteristic error concealing apparatus comprising:
a calculation unit operable to calculate a characteristic value of each block included in a picture, the characteristic value being used in deblocking filtering for the bock and representing strength of the deblocking filtering;
a control unit operable to control said calculation unit (i) to start and terminate the calculation for the block, and (ii) to designate locations of boundaries of the block;
a detection unit operable to detect an error related to the calculation; and
a concealment unit operable to conceal erroneous deblocking filtering, the concealment being performed for each of a block for which the error is detected and blocks subsequent to the block with the error, when the error is detected.

2. The filtering characteristic error concealing apparatus according to claim 1,
wherein said calculation unit is operable to calculate the characteristic value, based on a coding parameter representing information regarding a method of coding the picture, and
said detection unit is operable to detect the error, by judging whether or not the coding parameter is within a predetermined value

3. The filtering characteristic error concealing apparatus according to claim 1,
wherein said detection unit is operable to detect the error, by judging whether or not the characteristic value calculated by said calculation unit is within a predetermined value range.

4. The filtering characteristic error concealing apparatus according to claim 1,
wherein said control unit has: a sequence circuit operable to control said calculation unit; and a state register which holds information regarding a state of said sequence circuit, and
said detection unit is operable to detect the error, by judging whether or not transition of the states of said sequence circuit proceeds normally.

5. The filtering characteristic error concealing apparatus according to claim 1,
wherein said control unit has: a sequence circuit operable to control said calculation unit; and a state register which holds information regarding a state of said sequence circuit, and
said detection unit is operable to detect the error, by judging whether or not said control unit is in a runaway state.

6. The filtering characteristic error concealing apparatus according to claim 1,
wherein said control unit is initialized in starting calculation of a characteristic value for a first block in a macroblock which is subsequent to a macroblock including a block for which the error is detected, when the error is detected.

7. The filtering characteristic error concealing apparatus according to claim 6,
wherein said concealment unit is operable to prohibit deblocking filtering, for each of a block for which the error is detected and blocks subsequent to the block with the error.

8. The filtering characteristic error concealing apparatus according to claim 6,
wherein said concealment unit is operable to replace the erroneous characteristic value by an alternative value to be used in deblocking filtering, for each of a block for which the error is detected and blocks subsequent to the block with the error,

9. The filtering characteristic error concealing apparatus according to claim 8,
wherein said concealment unit has a characteristic table which holds a representative characteristic value, and
said concealment unit is operable to replace the erroneous characteristic value by the representative characteristic value to be used in deblocking filtering, for each of a block for which the error is detected and blocks subsequent to the block with the error.

10. The filtering characteristic error concealing apparatus according to claim 9,
wherein said characteristic table holds the representative value corresponding to a location of each block in the picture.

11. The filtering characteristic error concealing apparatus according to claim 8,
wherein said concealment unit has a storage unit which stores a calculated characteristic value for each block, and
said concealment unit is operable to replace the erroneous characteristic value by the stored characteristic value to be used in deblocking filtering, for each of the block for which the error is detected and blocks subsequent to the block with the error.

12. The filtering characteristic error concealing apparatus according to claim 11,
wherein said concealment unit is operable to replace the erroneous characteristic value by a characteristic value for a block adjacent to a current block, in order to be used in deblocking filtering, for each of a block for which the error is detected and blocks subsequent to the block with error.

13. The filtering characteristic error concealing apparatus according to claim 11,
wherein the characteristic value includes a horizontal boundary value used to filter a horizontal boundary in a block, and a vertical boundary value used to filter a vertical boundary in a block,
said concealment unit is operable to replace the erroneous characteristic value by a characteristic value including (a) a horizontal boundary value for a block which is positioned immediately above the current block, and (b) a vertical boundary value for a block which is positioned on immediately left of a current block, in order to be used in deblocking filtering, for each of a block for which the error is detected and blocks subsequent to the block with the error.

14. The filtering characteristic error concealing apparatus according to claim 10,
wherein said storage unit is operable to store: a characteristic value of each block included in a current macroblock which is currently decoded; and a characteristic value of each block included in a macroblock positioned immediately prior to the current macroblock, and
said concealment unit is operable to replace the erroneous characteristic value by a characteristic value for the block included in the macroblock positioned immediately prior to the current macroblock, in order to be used in deblocking filtering, for each of a block for which the error is detected and blocks subsequent to the block with the error.

15. The filtering characteristic error concealing apparatus according to claim 11,
wherein said storage unit is operable to store calculated characteristic values for respective blocks included in macroblocks whose number is equal to the number of macroblocks in one macroblock line, the macroblocks being followed by a current macroblock, and
said concealment unit is operable to replace the erroneous characteristic value by a characteristic value for a block which is included in a macroblock adjacent to the current macroblock and which is positioned in the adjacent macroblock at the same location of a current block, in order to be used in deblocking filtering, for each of a block for which the error is detected and blocks subsequent to the block with the error.

16. The filtering characteristic error concealing apparatus according to claim 9,
wherein said concealment unit has: a characteristic table which holds a representative characteristic value; and a storage unit which stores a calculated characteristic value for each block, and
said concealment unit is operable to (a) replace the erroneous characteristic value by a calculated characteristic value for a block adjacent to the current block when said storage unit stores the characteristic value for the adjacent block, and (b) replace the erroneous characteristic value by a representative characteristic value stored in said representative table when said storage unit does not store the characteristic value for the adjacent block, in order to be used in deblocking filtering, for each of a block for which the error is detected and blocks subsequent to the block, when the error is detected.

17. The filtering characteristic error concealing apparatus according to claim 10,
wherein in said characteristic table, the characteristic value is able to be written and read out, at a arbitrary timing.

18. The filtering characteristic error concealing apparatus according to claim 1,
wherein said control unit is operable to control said calculation unit to re-calculate the erroneous characteristic value, prior to completion of the concealing performed by said concealment unit, when the error is detected.

19. A filtering characteristic error concealing method comprising,
calculating a characteristic value of each block included in a picture, the characteristic value being used in deblocking filtering for the bock and representing strength of the deblocking filtering;
detecting an error related to the calculation; and
concealing erroneous deblocking filtering, the concealment being performed for each of a block for which the error is detected and blocks subsequent to the block with the error, when the error is detected.

20. A picture coding device comprising,
a calculation unit operable to calculate a characteristic value of each block included in a picture, the characteristic value being used in deblocking filtering for the bock and representing strength of the deblocking filtering;
a control unit operable to control said calculation unit (i) to start and terminate the calculation for the block, and (ii) to designate locations of boundaries of the block;
a detection unit operable to detect an error related to the calculation; and
a concealment unit operable to conceal erroneous deblocking filtering, the concealment being performed for each of a block for which the error is detected and blocks subsequent to the block with the error, when the error is detected.
